(19) United States
(12) Patent Application Publication
(10) Pub. No.: US 2024/0390715 A1
(43) Pub. Date: Nov. 28, 2024

(54) Fire Suppression Apparatus

(71) Applicant: Purple Valor L.L.C., Elizabethtown, KY (US)

(72) Inventor: Joshua D. Strickland, Elizabethtown, KY (US)

(21) Appl. No.: 18/674,488

(22) Filed: May 24, 2024

Related U.S. Application Data
(60) Provisional application No. 63/504,122, filed on May 24, 2023.

(51) Int. Cl. A62C 15/00; A62C 2/06

(52) U.S. Cl. CPC A62C 15/00; A62C 2/06

(57) ABSTRACT

A fire suppression apparatus includes a flexible container and a fire suppression composition. The flexible container comprises an internal compartment to enclose the fire suppression composition. The flexible container is configured to tear or puncture at a predetermined pressure so as to release the fire suppression composition.

### FIELD OF THE INVENTION

The present invention relates generally to fire suppression apparatus. More specifically, the present invention is a fire suppression apparatus that releases a fire suppression composition in response to kinetic energy. The present invention is specifically designed for cleaning spills of water from a bathtub or a sink. However, the present invention is not limited to this option, and it may further be adapted for different purposes.

### BACKGROUND OF THE INVENTION

Officially standardized in World War I, soldiers wore a utility belt/suspender combination system, commonly known as Load Bearing Equipment (LBE), throughout the rest of the 20th century. With the advancement of plate armor and plate carrier systems, the “Chest Rig” was introduced into the United States Special Operations Command (“SOCOM”) in the 1990's. The “Chest Rig” configuration is now an Army wide standard for all Service Members (SM). While several different “Chest Rigs” have been used, the common denominator is the location of ammunition. If any SM takes a direct, frontal, small arms hit, a serious risk of a secondary explosion commonly known as a “cook-off”′ of ammunition is presented. The odds of this happening increase, due to the SM being trained to square up and advance towards enemy contact. The unprotected neck/face of the SM may be vulnerable to serious injury or death from a sympathetic ammunition explosion on his chest. Given the variable time between the initial impact and detonation of a cook-off, the risk extends to the first responding SM rendering aid to the wounded. Currently, chest plates are designed to absorb most of the detonation, but the chance of injury, burns, and death persists.

Therefore, it is an objective of the present invention to provide a fire suppression apparatus that overcomes the problems set forth above.

### SUMMARY OF THE INVENTION

The present invention discloses a fire suppression apparatus that includes a flexible container and a fire suppression composition. The flexible container comprises an internal compartment to enclose the fire suppression composition. The flexible container is configured to tear or puncture at a predetermined pressure so as to release the fire suppression composition.

In one embodiment, the flexible container comprises a top wall and a bottom wall, and the internal compartment is formed by attaching the top wall and the bottom wall together.

In one embodiment, the internal compartment is vacuum sealed.

In one embodiment, the flexible container is made of plastic.

In one embodiment, the flexible container has a rectangular shape.

In one embodiment, a thickness of the flexible container is less than one inch.

In one embodiment, the present invention further comprises at least one additional flexible containers

In one embodiment, the fire suppression composition is non-toxic.

In one embodiment, the fire suppression composition comprises a mixture of vinegar, baking soda, and dish soap.

In one embodiment, the mixture further comprises sodium chloride.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a top view of the present invention.

FIG. 2 depicts a front view of the present invention.

FIG. 3 depicts a right-side view of the present invention.

FIG. 4 depicts a cross-sectional view of the present invention, taken along the line A-A in FIG. 3.

FIG. 5 depicts multiple instances of the present invention used in tandem.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of fire suppression apparatuses, embodiments of the present disclosure are not limited to use only in this context.

The present invention is a fire suppression apparatus that is specifically designed to be used in chest rigs, tactical vests, ammo bandoliers, etc. It is an aim of the present invention to provide a fire suppression apparatus that conforms to the user's body. It is an aim of the present invention to provide a fire suppression apparatus that can react to kinetic energy to suppress a fire. It is yet another aim of the present invention to provide a fire suppression apparatus that is simple in structure, light in weight, inexpensive to manufacture, and easy to use.

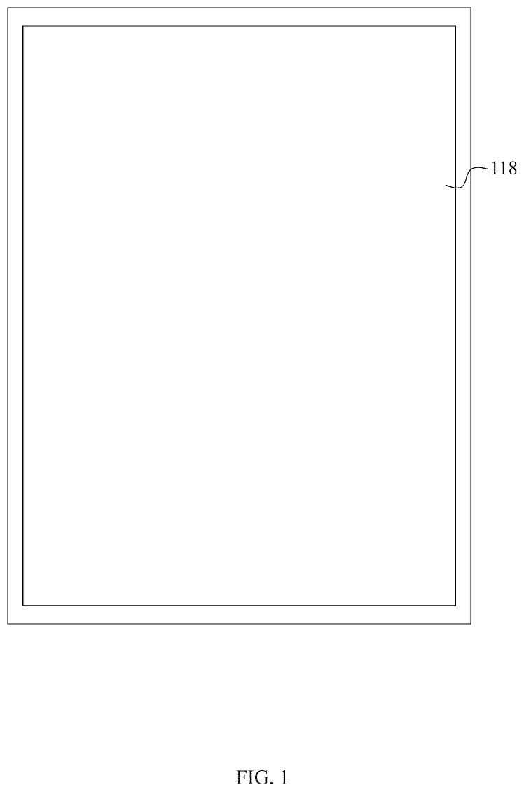

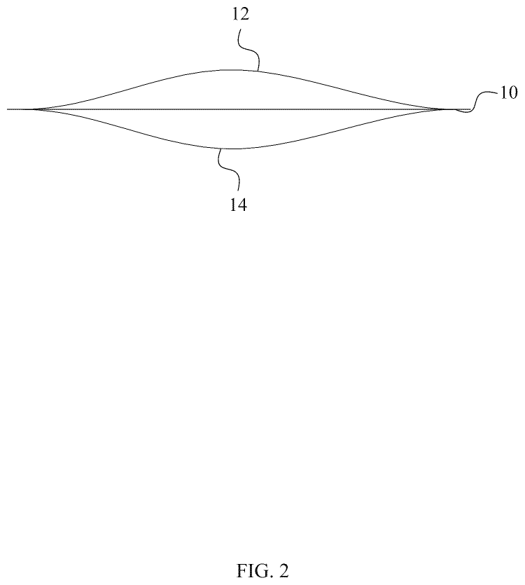

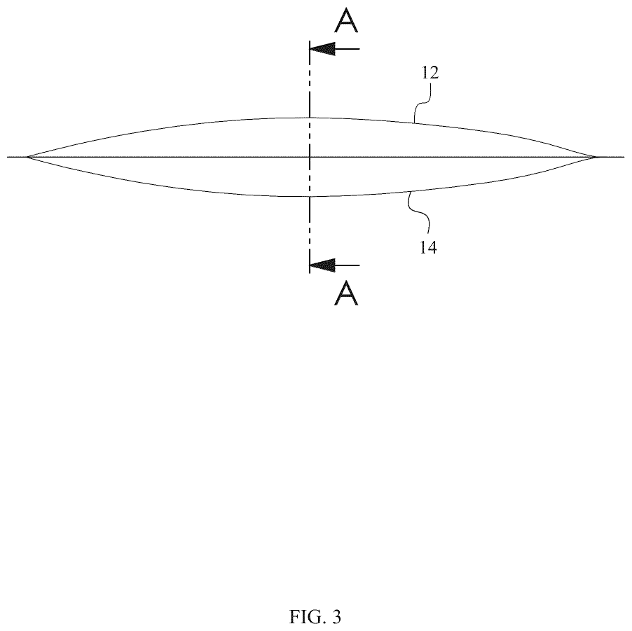

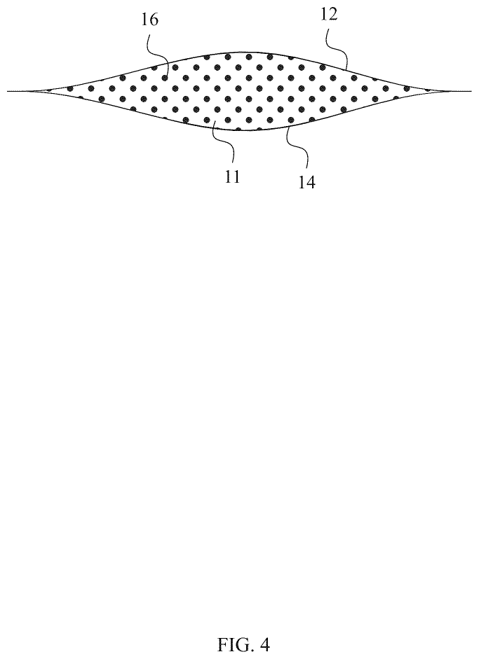

Referring now to the figures of the present disclosure. FIGS. 1-4 illustrate the components of the present invention. The present invention is a fire suppression apparatus comprising a flexible container 10 and a fire suppression composition 16.

The flexible container 10 is configured to accommodate the fire suppression composition 16. It should be noted that the flexible container 10 can be of any shape, size, material, features, type or kind, orientation, location, quantity, components, and arrangements of components that would allow the present invention to fulfill the objectives and intents of the present invention. In one embodiment, the flexible container 10 comprises an internal compartment 11 to enclose the fire suppression composition 16. The flexible container 10 is configured to tear or puncture at a predetermined pressure. For example, the predetermined pressure may be set to the minimum pressure for a bullet to impact such that the flexible container 10 will tear or puncture when struck by a bullet. As an example, the predetermined pressure may be set to 20,000 PSI. In another embodiment, the flexible container 10 may also be configured to tear or rupture at a predetermined temperature so as to release the fire suppression composition 16. For example, the flexible container 10 may melt at high temperature so as to release the fire suppression composition 16.

In one embodiment, the flexible container 10 comprises a top wall 12 and a bottom wall 14, and the internal compartment 11 is formed by attaching the top wall 12 and the bottom wall 14 together. In a preferred embodiment, the internal compartment 11 is vacuum sealed. In one embodiment, the flexible container is made of plastic or any other suitable materials. In one embodiment, the flexible container has a rectangular shape. However, it is contemplated that other shapes, such as but not limited to circle, triangle, round, elliptical, polygon, or any superposition of these shapes, are also possible. The flexible container 10 is wearable and form-fitting to ensure proper coverage of the gear worn by the user. In an alternative embodiment the plastic bag is designed as a hard bladder that is semi-flexible. In one embodiment, a thickness of the flexible container 10 is less than one inch. It should be noted that the flexible container 10 is scalable to meet various needs and conditions.

The fire suppression composition 16 is configured to suppress or prevent an explosion or flame from harming the user when being worn. It should be noted that the fire suppression composition 16 can be of any shape, size, material, features, type or kind, orientation, location, quantity, components, and arrangements of components that would allow the present invention to fulfill the objectives and intents of the present invention. It is preferred that the fire suppression composition 16 is a dry powder that reacts to kinetic energy. It is also preferred that the fire suppression composition 16 is non-toxic. In one embodiment, the fire suppression composition 16 includes a mixture of vinegar, baking soda, and dish soap. The dish soap preferably comprises monoammonium phosphate. In one embodiment, the mixture further comprises sodium chloride. Preferably, the mixture comprises 50% baking soda in weight, 40% vinegar in weight, 10% dish soap in weight, and 10 sodium chloride in weight.

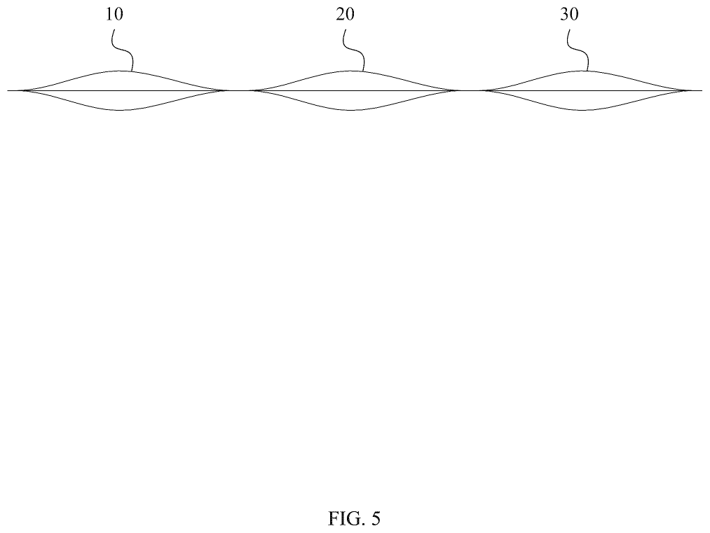

As shown in FIG. 5, the present invention may further comprise at least one additional flexible containers. The at least one additional flexible container may connect to the flexible container 10 such that the multiple flexible containers may be used in tandem. Although there are two additional flexible containers 20 and 30 shown in FIG. 5, it should be noted that any other number of additional flexible containers may also be considered.

The present invention is a non-toxic fire suppression apparatus that mitigates or eliminates secondary detonations in ammunition carried on the chest. The present invention provides users with an apparatus that can extinguish ammunition on impact. The present invention intends to provide users with an apparatus that prevents cook-offs and limits shrapnel. The components of the present invention allow for the user to conform to the present invention to fit the shape of various objects being carried. Furthermore, the present invention can be quickly installed into various types of gear in less than one minute.

Although the disclosure has been explained in relation to its preferred embodiment, it is to be understood that many other possible modifications and variations can be made without departing from the spirit and scope of the disclosure.

What is claimed is:

1. A fire suppression apparatus comprising:
a flexible container;
a fire suppression composition;
the flexible container comprising an internal compartment to enclose the fire suppression composition; and
the flexible container being configured to tear or puncture at a predetermined pressure so as to release the fire suppression composition.

2. The fire suppression apparatus as claimed in claim 1, wherein the flexible container comprises a top wall and a bottom wall, and the internal compartment is formed by attaching the top wall and the bottom wall together.

3. The fire suppression apparatus as claimed in claim 1, wherein the internal compartment is vacuum sealed.

4. The fire suppression apparatus as claimed in claim 1, wherein the flexible container is made of plastic.

5. The fire suppression apparatus as claimed in claim 1, wherein the flexible container has a rectangular shape.

6. The fire suppression apparatus as claimed in claim 1, wherein a thickness of the flexible container is less than one inch.

7. The fire suppression apparatus as claimed in claim 1, further comprising at least one additional flexible containers.

8. The fire suppression apparatus as claimed in claim 1, wherein the fire suppression composition is non-toxic.

9. The fire suppression apparatus as claimed in claim 1, wherein the fire suppression composition comprises a mixture of vinegar, baking soda, and dish soap.

10. The fire suppression apparatus as claimed in claim 8, wherein the mixture further comprises sodium chloride.

11. A fire suppression apparatus comprising:
a flexible container;
a fire suppression composition;
the flexible container comprising an internal compartment to enclose the fire suppression composition;
the flexible container comprising a top wall and a bottom wall;
the internal compartment being formed by attaching the top wall and the bottom wall together;
the flexible container being configured to tear or puncture at a predetermined pressure; and
the fire suppression composition comprising a mixture of vinegar, baking soda, dish soap, and sodium chloride.

12. The fire suppression apparatus as claimed in claim 11, wherein the internal compartment is vacuum sealed.

13. The fire suppression apparatus as claimed in claim 12, wherein the flexible container is made of plastic.

14. The fire suppression apparatus as claimed in claim 13, wherein the flexible container has a rectangular shape.

15. The fire suppression apparatus as claimed in claim 14, wherein a thickness of the flexible container is less than one inch.

16. The fire suppression apparatus as claimed in claim 11, wherein the fire suppression composition is non-toxic.
